(19) United States
(12) Patent Application Publication
(10) Pub. No.: US 2008/0056209 A1
(43) Pub. Date: Mar. 6, 2008

(54) Wireless Backbone to Connect Wireless Cells

(75) Inventors: William Raphael Newman, Norfolk (GB); Mark Henry Wagg, Norfolk (GB); Christopher George Sainty, Norfolk (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Newman Concepts Ltd., Dersingham, Norfolk (GB)

(21) Appl. No.: 11/575,298

(22) PCT Filed: Aug. 23, 2005
(86) PCT No.: PCT/GB05/03299

§ 371 Date: Apr. 19, 2007

(30) Foreign Application Priority Data
Sep. 29, 2004 (GB) 0421610.7

(51) Int. Cl. H04Q 7/24

(52) U.S. Cl. 370/338

(57) ABSTRACT

A communication system comprising a network interface device; a first coupling device for coupling a first network to a first wireless communication link; a second coupling device for coupling a second network to a second wireless communication link; wherein the first wireless communication link and the second wireless communication link are arranged to form a network backbone communication connection coupled to the network interface device to allow a first communication link to be established between the network interface device and the first coupling device and a second communication link to be established between the network interface device and the second coupling device.

The present invention relates to a wireless communication system.

Wireless networking is becoming increasingly popular both within local area networks LANs and wide area networks WANs.

Within local area networks office users have become accustomed to flexibility and portability provided by wireless LANs. Although wireless WANs have been proposed for use in rural communities as of yet they have failed to deliver the performance required for wide spread use.

The use and philosophy of wireless networking is currently based upon standard radio techniques where a transmitter is used to send and receive wireless network signals to clients within the transmitters transmitting range, otherwise known as a network cell. To extend the range of the network cell a wireless network repeater is placed within the cell where the repeater is arranged to communicate with the transmitter to boost and retransmit signals from the transmitter, thereby increasing the range of the wireless network. To extend the network further distances additional repeaters are used, thereby resulting in an increase size of the network cell. For extended distances repeaters can be used to create point to point links thereby allowing more distant clients to be serviced, however the clients still form part of the same network cell.

Using the above technique results in the creation of a single network in which all transmitted signals are broadcast over the whole network. However, this can result in a degradation of network capacity and increase in latency. Although this is suitable for typical radio broadcasting purposes in which all network users are required to have access to all the transmitted signals this is undesirable in a computer network environment that is spread over a large distance and where high speed communication is required between specific users.

It is desirable to improve this situation.

In accordance with the present invention, there is provided a communication system as defined in the appendant independent claim, to which reference should now be made. Embodiments of the present invention are defined in the appendant dependent claims, to which reference should also now be made.

This provides the advantage of allowing wireless point to point communication links to be established between different network entities, thereby avoiding broadcasting data over networks that do not require access to the data, which has the further advantage of minimising degradation in network capacity (i.e. bandwidth) and latency in the data being transmitted.

The present invention will now be described, by way of example, with reference to the accompanying drawings, in which:

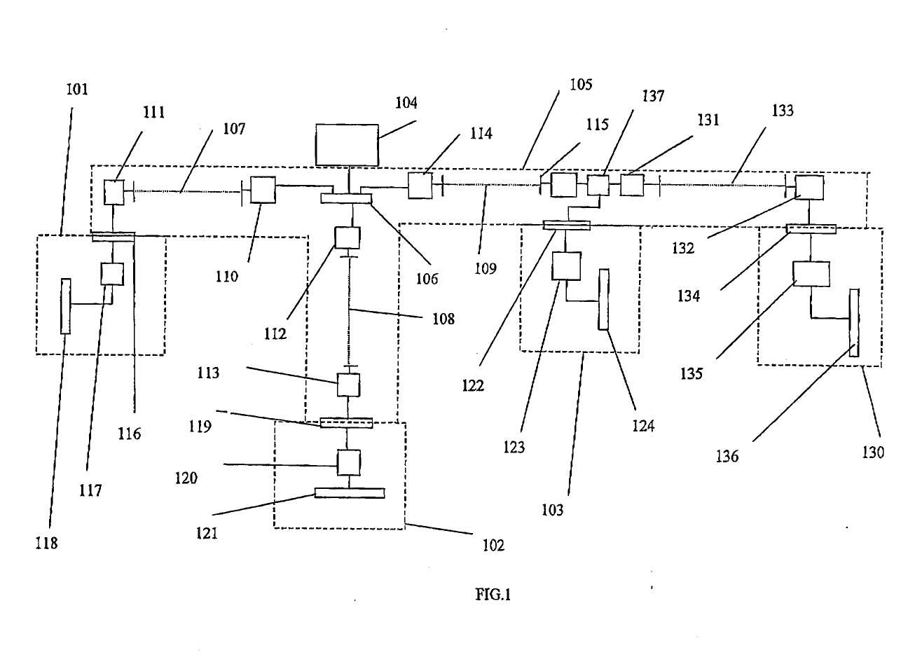

FIG. 1 illustrates a network system incorporating a communication system according to a first embodiment of the present invention;

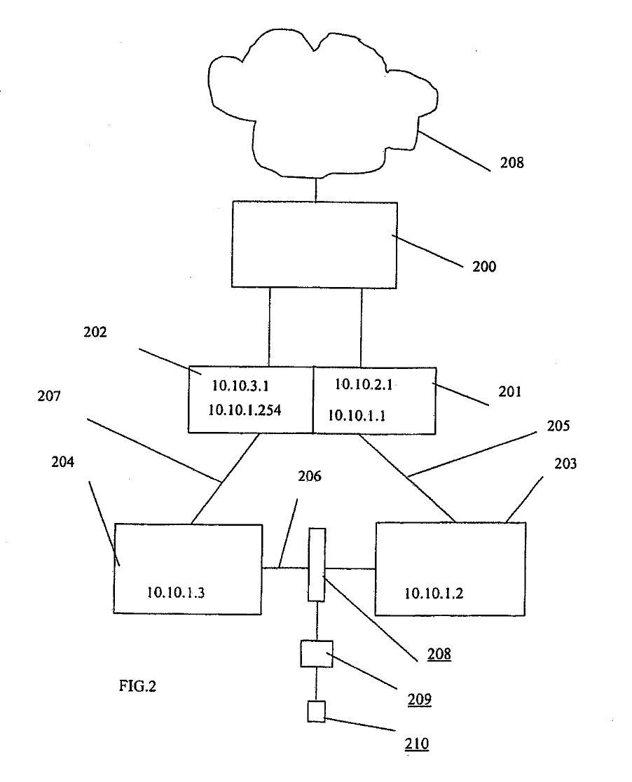

FIG. 2 illustrates a network system according to a second embodiment of the present invention.

FIG. 1 shows four wireless network cells 101, 102, 103, 130 coupled to a network interface device 104, which in this embodiment is a router (i.e. a gateway), via a network backbone communication connection 105, otherwise known as a network backbone. The gateway 104 acts as an interface between the network backbone 105 and an external network (not shown), for example the Internet, however the gateway 104 could couple the network backbone 105 to other networks.

The gateway 104 is interfaced to the network backbone 105 via a first switch 106 where the network backbone 105 includes a first wireless communication link 107, a second wireless communication link 108, a third wireless communication link 109, and a fourth wireless communication link 133.

Although the current embodiment shows the network backbone 105 having four wireless communication links 107, 108, 109, 133 the network backbone 105 may only include two wireless communication links, or alternatively three or more, depending upon the number of separate networks that require access to the external network. As such, the network backbone 105 could incorporate any number of wireless communication links.

The wireless communication links 107, 108, 109, 133 can be arranged and added to, to extend over a range of distances, over may kilometres per wireless link. As such, the network backbone 105 can be arranged to extend over a relatively short distance to provide a network backbone 105 for a LAN implementation, for example in an office environment, or alternatively could be used over an extended distance to provide a network backbone 105 in a WAN implementation, for example for the provision of networking facilities in rural communities.

The first wireless communication link 107 includes a first wireless transceiver access point 110 that is hardwired to the switch 106. Associated with the first wireless transceiver access point 110 is a second wireless transceiver access point 111 where the first wireless transceiver access point 110 and the second wireless transceiver access point 111 are configured to operate in bridge mode to allow a wireless point to point communication link to be established between the first wireless transceiver access point 110 and the second wireless transceiver access point 111. Accordingly, the first wireless transceiver access point 110 and second wireless transceiver access point 111 will typically be a bridge link.

The second wireless communication link 108 includes a third wireless transceiver access point 112 that is hardwired to the switch 106. Associated with the third wireless transceiver access point 112 is a fourth wireless transceiver access point 113 where the third wireless transceiver access point 112 and the fourth wireless transceiver access point 113 are configured to operate in bridge mode to allow a wireless point to point communication link to be established between the third wireless transceiver access point 112 and the fourth wireless transceiver access point 113.

The third wireless communication link 109 includes a fifth wireless transceiver access point 114 that is hardwired to the switch 106. Associated with the fifth wireless transceiver access point 114 is a sixth wireless transceiver access point 115 where the fifth wireless transceiver access point 114 and the sixth wireless transceiver access point 115 are configured to operate in bridge mode to allow a wireless point to point communication link to be established between the fifth wireless transceiver access point 114 and the sixth wireless transceiver access point 115.

The fourth wireless communication link includes a tenth wireless transceiver access point 131, which is coupled to the sixth wireless transceiver access point 115 via a second switch 137 to allow data to be communicated between the sixth wireless transceiver access point and the tenth wireless transceiver access point 131. Associated with the tenth wireless transceiver access point 131 is an eleventh wireless transceiver access point 132 where the tenth wireless transceiver access point 131 and the eleventh wireless transceiver access point 132 are configured to operate in bridge mode to allow a wireless point to point communication link 133 to be established between the tenth wireless transceiver access point 131 and the eleventh wireless transceiver access point 132.

The second wireless transceiver access point 111 is coupled to a router 116, which forms part of the first wireless network cell 101, to which is coupled a seventh wireless transceiver access point 117 that is configured to operate as a wireless network interface that allows the first wireless network cell 101 to be formed. Additionally, the seventh wireless access point 117 acts as a coupling device for coupling the first wireless network cell 101 to the network backbone 105, via the router 116. To allow a 360° network coverage the seventh wireless transceiver access point 117 uses a 360° omni directional aerial 118, however other types of aerials could be used.

The fourth wireless transceiver access point 113 is coupled to a router 119, which forms part of the second wireless cell 102, to which is coupled a eighth wireless transceiver access point 120 that is configured to operate as a wireless network interface that allows the second wireless network cell 102 to be formed. Additionally, the eighth wireless access point 120 acts as a coupling device for coupling the second wireless network cell 102 to the network backbone 105, via the router 119. To allow a 360° network coverage the eighth wireless transceiver access point 120 uses a 360° omni directional aerial 121, however other types of aerials could be used.

As stated above, the sixth wireless transceiver access point 115 is coupled to the second switch 137, which in addition to being coupled to the tenth wireless transceiver access point 131 is also coupled to a router 122, which forms part of the third wireless cell 103. The router 122 is coupled to a ninth wireless transceiver access point 123 that is configured to operate as a wireless network interface that allows the third wireless network cell 103 to be formed. Additionally, the ninth wireless transceiver access point 123 acts as a coupling device for coupling the third wireless network cell 103 to the network backbone 105, via router 122. To allow a 360° network coverage the ninth wireless transceiver access point 123 uses a 360° omni directional aerial 124, however other types of aerials could be used.

The eleventh wireless transceiver access point 132 is coupled to a router 134, which forms part of the fourth wireless cell 130, to which is coupled a twelfth wireless transceiver access point 135 that is configured to operate as a wireless network interface that allows the fourth wireless network cell 103 to be formed. Additionally, the twelfth wireless transceiver access point 135 acts as a coupling device for coupling the fourth wireless network cell 130 to the network backbone communication channel 105, via router 134. To allow a 360° network coverage the twelfth wireless transceiver access point 135 uses a 360° omni directional aerial 136, however other types of aerials could be used.

To extend the network backbone 105 a switch (not shown) could be installed after the second wireless transceiver access point 111, the fourth wireless transceiver access point 113 and/or the sixth wireless transceiver access point 115 to allow an additional wireless communication link to be created from the switch (not shown). As stated above, using this method the network backbone communication channel 105 can be extended by any number of additional wireless communication links. Accordingly, the network backbone 105, which includes communication links 107, 108, 109, 133, is able to communicate data to a specific network cell without the corresponding data being sent to other network cells, thereby optimising network bandwidth and reducing latency.

The use of the routers 116, 119, 122, 134 in the first wireless network cell 101, the second wireless network cell 102, the third wireless network cell 103 and the fourth wireless network cell 130 allows the first wireless network cell 101, the second wireless network cell 102, the third wireless network cell 103 and the fourth network cell 130 to have their own separate network addresses. As such, this allows the number of users for each network cell to be determined by the subnet mask associated with each of the network cells. As such, if the first wireless network cell 101, the second wireless network cell 102, the third wireless network cell 103 and the fourth wireless network cell 130 have a subnet mask of 255.255.255.0 each network cell could support up to 255 users. Accordingly, if network cell size is not important the routers 116, 119, 122, 134 can be removed from the network.

For the purposes of the present embodiment the wireless technology used for the wireless communication links 107, 108, 109, 131 is based upon the IEEE 802.11 standard, which imposes several requirements for the RF transmission characteristics of the network system. For example, a 2.4 GHz wireless frequency band is provided, which for the European market incorporates thirteen channels and for the North American market incorporates 11 channels. Each channel has a channel bandwidth of 22 MHz.

To avoid channel interference between wireless communication links that form the wireless network backbone 105 and/or the wireless network cells (i.e. hops between different wireless links) different channel frequencies are used between adjacent wireless communication links and/or wireless network cells. However, for a wireless communication link and/or network cell that is sufficiently far from another wireless communication link and/or network cell such that the signal strength from the another wireless communication link and/or network cell in the region of the wireless communication link is below a threshold value then the specific channel frequency of the another wireless communication link can be reused. The chosen signal strength threshold will depend upon network configuration and bandwidth requirements. Further, the distance from the RF source will vary for backbone communication links and wireless network cells, where power levels will typically be different. Consequently interference from adjacent wireless communication links can be minimised while allowing reuse of the available frequency spectrum.

By way of illustration to allow a communication link to be established between the first wireless network cell 101, the second wireless network cell 102, the third wireless network cell 103, the fourth wireless network cell 130 and the network interface device 104 IP addresses are assigned to the respective network components. For example, for the purposes of this embodiment the range of IP private addresses assigned to the network structure shown in FIG. 1 is 10.10.0.0 where the network backbone 105 elements use the IP ranges 10.10.1.0 to 10.10.1.12. In particular, the first wireless transceiver access point 110 uses 10.10.1.1, the second wireless transceiver access point 111 uses 10.10.1.2, the first wireless communication link side of the router 116 is 10.10.1.3, the third wireless transceiver access point 112 uses 10.10.1.4, the fourth wireless transceiver access point 113 uses 10.10.1.5, the second wireless communication link side of the router 119 is 10.10.1.6, the fifth wireless transceiver access point 114 uses 10.10.1.7, the sixth wireless transceiver access point 115 uses 10.10.1.8, the third wireless communication link side of the router 122 is 10.10.1.9. For the fourth wireless communication link 133 the tenth wireless access point 131 uses 10.10.1.10 and the eleventh wireless access point 132 uses 10.10.1.11, with the associated router for the fourth wireless communication link 133 having an IP address of 10.10.1.12.

The first wireless network cell 101 uses the IP range 10.10.13, where the first network cell side of the router 116 has an IP address 10.10.13.1 and the seventh wireless transceiver access point 117 uses 10.10.13.2.

The second wireless network cell 102 uses the IP range 10.10.14, where the second network cell side of the router 119 has an IP address 10.10.14.1 and the eighth wireless transceiver access point 120 uses 10.10.14.2.

The third wireless network cell 103 uses the IP range 10.10.15, where the third network cell side of the router 122 has an IP address 10.10.15.1 and the ninth wireless transceiver access point 123 uses 10.10.15.2.

The fourth wireless network cell 130 uses the IP range 10.10.16, where the third network cell side of the router 122 has an IP address 10.10.16.1 and the ninth wireless transceiver access point 123 uses 10.10.16.2.

The first wireless communication link 107 is configured to operate on the first 802.11 assigned channel having a frequency centred on 2.412 GHz. The second wireless communication link 108 is in relatively close proximity to the first wireless communication link 107, and as such signal strength from the first wireless communication link 107 in the region of the second wireless communication link 108 is above a threshold. Consequently the second wireless communication link 108 is configured to operate on the sixth 802.11 assigned channel having a frequency centred on 2.43 GHz, thereby ensuring no interference between the first wireless communication link 107 and the second wireless communication link 108. The third wireless communication link 109 is also in relatively close proximity to the first wireless communication link 107 and the second wireless communication link 108, as such signal strength from the first wireless communication link 107 and the second wireless communication link 108 in the region of the third wireless communication link 108 is above a threshold. Consequently the third wireless communication link 109 is configured to operate on the eleventh 802.11 assigned channel having a frequency centred on 2.462 GHz. However, as the fourth wireless communication link 133 is sufficiently far from the first wireless communication link 107 that the received signal from the first wireless communication link 107 is below a threshold. As such, the fourth wireless communication link 133 is configured to use the first 802.11 channel having a frequency centred on 2.412 GHz.

Although the above chosen channel frequencies have been selected to provide good channel separation these channel frequencies are merely for illustrative purposes and any suitable channel frequencies may be used.

As would be appreciated by a person skilled in the art the above IP ranges are merely for illustration and any available range of IP addresses could be used.

The seventh wireless transceiver access point 117, the eighth wireless transceiver access point 120, the ninth wireless transceiver access point 123 and the twelfth wireless transceiver access point 135 are arranged to provide appropriate IP addresses to users logging onto their respective network cell, thereby allowing communication links to be established between the gateway 104 and the individual users via the network backbone communication channel 105, thereby providing the advantage of avoiding network traffic from one wireless network cell being passed through another wireless network cell on route to the gateway 104.

Further, the network structure described above can be configured to allow the point to point links established over the network backbone communication channel to address the media access control MAC addresses associated with the respective network devices. As such, this allows MAC filtering to be used where communication with equipment coupled to the network backbone communication channel 105 that have unauthorised MAC addresses can be terminated.

Although the above description describes the use of a first wireless network cell 101, a second wireless network cell 102, a third wireless network cell 103 and a fourth wireless network cell 130 one or more of these cell could equally be configured as a wired network cell.

To enhance communication reliability over a network communication backbone a network communication backbone can be configured to form a ‘ring’, where the end of the network communication backbone is coupled to the beginning of the network communication backbone, thereby forming a network communication ‘rib’.

By coupling the end of the network communication backbone to the beginning of the network communication backbone allows traffic to be automatically redirected over the network communication backbone in the event of a failure of one element of the network communication backbone, thereby allowing the network to remain operational.

To overcome a limitation of TCP/IP networks in which duplicate IP addresses are not allowed and thereby prevent the coupling of one end of a network communication backbone to the other end of the network communication backbone, the inventors have realised that by using a head router it is possible to overcome this limitation and couple the beginning of a TCP/IP network communication backbone to its end.

This is achieved using a head router that is arranged to use two network connections on different networks, where each respective network connection is coupled to a sub router, where the two sub routers acts as a dual gateway router. Each of the sub-routers that form the dual gateway router have a network connection on the same network, thereby allowing one sub-router to be coupled to one end of the network communication backbone and the other sub-router to be coupled to the other end of the network communication backbone. This allows the head router, which acts as a gateway to a different network, for example the Internet, to transmit onto the network communication backbone via either sub-router (i.e. in either direction around the network communication backbone) or alternatively for a user coupled to the network communication backbone to access the head router via either sub router, where the primary route would typically correspond to the shortest route. In the event of a failure of a device associated with the shortest route the route to/from the head router would automatically change to the alternate route, alternately this could be reconfigured remotely by a service engineer.

This is illustrated in FIG. 2, in which a network communication ‘rib’ is established via a head router 200.

FIG. 2 shows the head router 200 (i.e. a gateway between two networks) coupled to a first sub-router 201 and a second sub-router 202, which as stated above acts as a dual gateway router. The IP address of the first sub-router 200 for the connection with the head router 200 is 10.10.2.1. The IP address of the second sub-router 202 for the connection with the head router 200 is 10.10.3.1. Consequently, the head router 200 sees the first sub-router 201 and second sub-router 202 as two separate networks.

In addition to the network connection between the first sub-router 201 and head router 200 a second network connection is made between the first sub-router 201 and a first access point 203, otherwise known as a bridge link, where the IP addresses between the first sub-router and first access point are 10.10.1.1 and 10.10.1.2 respectively and forms the first communication link 205 of a network communication backbone. The first access point 203 acts as an access point to the network communication backbone in a similar or same fashion to the access points described in the first embodiment described above.

In addition to the first access point 203 being coupled to the first sub-router 201, the first access point 203 is also coupled to a second access point 204 (i.e. a second bridge link), where the IP addresses of the first access point and second access point are 10.10.1.2 and 10.10.1.3 respectively and forms the second communication link 206 of a network communication backbone. The second access point 204 acts as an access point to the network communication backbone in a similar or same fashion to the first access point 203.

The second access point 204 is additionally coupled to the second sub-router 202, where the IP addresses between the second access point 204 and the second sub-router 202 are 10.10.1.3 and 10.10.1.254 respectively and forms the third communication link 207 of the network communication backbone.

Accordingly, a network communication backbone is formed between the first sub-router and the second sub-router from IP addresses 10.10.1.1 to 10.10.1.254 via the first, second and third communication links 205, 206, 207. The respective communication links 205, 206, 207 that form the network communication backbone can be implemented as either wireless communication links, as described above, or wired communication links.

In addition to the head router 200 being coupled to the first sub-router 201 and the second sub-router 202, the head router 200 is coupled to an external network 208, for example the Internet, for routing traffic between the network communication backbone and the Internet 208 in its role as a gateway.

Coupled between the first access point 203 and second access point 204 of the network communication backbone is a switch 208 to which is additionally coupled an additional router 209 (i.e. a first network cell router), which forms part of a first network cell (not shown) coupled to the network communication backbone. The first network cell router 209 is in turn coupled to a transceiver access point 210, for example a wireless transceiver access point, which allows the first network cell to be coupled to the network communication backbone, as described above.

As the first network cell forms a different network to the network communication backbone a different range of IP addresses are assigned to the first network cell. For example, the network communication backbone side of the first network cell router 209 may be given an IP address, for example, of 10.10.1.4 and the first network cell side of the router 209 be given an IP address 10.10.4.1. Accordingly, various user devices (not shown) that form the first network cell may then be coupled to an external network, for example the Internet 208, via the network communication backbone and the head router 200.

It should be noted, however, that although only a single network cell has been described coupled to the network communication backbone any suitable number of network cells can be coupled to the network communication backbone. Further, as would be appreciated by a person skilled in the art, the network communication backbone could comprise of any number of communication links.

As the head router 200 is coupled to the network communication backbone via both the first sub-router 201 and the second sub-router 202 the head router 200 is able to route data to and from the network communication backbone via either the first sub-router 201 or second sub-router 202. As such, if there is a failure of a communication link in the network communication backbone which forms part of the route from a user device on the first network cell to the head router 200 the first network cell router 209 can be configured to automatically direct traffic between the user device on the first network cell and the Internet 208 via the network communication backbone using an alternative route. By way of illustration if the first network cell router 209 is arrange to direct traffic to the head router 200 via the first sub-router 201 as the primary route, if a failure occurs via this route the first network cell router 209 will redirect the traffic to the second sub-router 202 upon detection of the failure on the primary route.

For example, if a user device on the first network cell wishes to access the Internet 208, where the first network cell router 209 is configured to access the first sub router 201, if the link between the first network cell router 209 and the first sub router 201 fails the first network cell router 209 is configured to automatically access the second sub router 202.

1-15. (canceled)

16. A communication system comprising a network interface device; a first coupling device for coupling a first network to a first wireless communication link; a second coupling device for coupling a second network to a second wireless communication link; wherein the first wireless communication link and the second wireless communication link are arranged to form a network backbone communication connection coupled to the network interface device to allow a first communication link to be established between the network interface device and the first coupling device and a second communication link to be established between the network interface device and the second coupling device.

17. A communication system according to claim 16, further comprising a first wireless network coupled to the first coupling device to form a wireless cell for allowing a plurality of users to establish respective communication links with the network interface device via the network backbone communication connection.

18. A communication system according to claim 16, further comprising a second wireless network coupled to the second coupling device to form a wireless cell for allowing a plurality of users to establish respective communication links with the network interface device via the network backbone communication connection.

19. A communication system according to claim 16, wherein the first coupling device is a network bridge.

20. A communication system according to claim 16, wherein the second coupling device is a network bridge.

21. A communication system according to claim 16, wherein network interface device is a router.

22. A communication system according to claim 16, wherein the network interface device is arranged to couple the network backbone communication connection to the Internet.

23. A communication system according to claim 16, further comprising a switch for allowing a branch to be formed off the network backbone communication connection.

24. A communication system according to claim 16, further comprising a first router arranged to be coupled between the first coupling device and the first network to allow a first network cell to be formed.

25. A communication system according to claim 16, further comprising a second router arranged to be coupled between the second coupling device and the second network to allow a second network cell to be formed.

26. A communication system according to claim 16, wherein the first wireless communication link or second wireless communication link is arranged to operate on the same channel frequency to another wireless communication link of the communication system when the signal strength of the another wireless communication link is below a predetermined threshold in the region of the first wireless communication link or second wireless communication link.

27. A communication system according to claim 16, wherein the first wireless communication link is formed between the first coupling device and the network interface device via a first router; the second wireless communication link is formed between the second coupling device and the network interface device via a second router and a third wireless communication link is established between the first coupling device and the second coupling device, wherein the first wireless communication link, the second wireless communication link and the third wireless communication link are arranged to form a network backbone communication connection.

28. A communication system according to claim 12, wherein the network backbone communication connection is arranged to operate in accordance with TCP/IP protocol.

29. A communication system according to claim 13, wherein the first router is arranged to communicate with the network interface device on a first network having a first IP network address and the second router is arranged to communicate with the network interface device on a second network having a second IP network address.

30. A communication system according to claim 12, wherein the first router is arranged to form one end of the network backbone communication connection and the second router is arranged to form another end of the network backbone communication connection.
